(19) United States
(12) Patent Application Publication
(10) Pub. No.: US 2022/0405547 A1
(43) Pub. Date: Dec. 22, 2022

(54) RESIDUAL NORMALIZATION FOR IMPROVED NEURAL NETWORK CLASSIFICATIONS

(71) Applicant: QUALCOMM Incorporated, San Diego, CA (US)

(72) Inventors: Byeonggeun KIM, Seoul (KR); Simyung Chang, Suwon (KR); Jangho Kim, Siheung (KR); Seunghan Yang, Incheon (KR); Kyu Woong Hwang, Daejeon (KR)

(21) Appl. No.: 17/807,479

(22) Filed: Jun. 17, 2022

Related U.S. Application Data
(60) Provisional application No. 63/212,017, filed on Jun. 17, 2021.

(51) Int. Cl. G06N 3/04; G06K 9/62

(52) U.S. Cl. CPC G06N 3/04; G06K 9/6251

(57) ABSTRACT

Certain aspects of the present disclosure provide techniques for residual normalization. A first tensor comprising a frequency dimension and a temporal dimension is accessed. A second tensor is generated by applying a frequency-based instance normalization operation to the first tensor, comprising, for each respective frequency bin in the frequency dimension, computing a respective frequency-specific mean of the first tensor. A third tensor is generated by: scaling the first tensor by a scale value, and aggregating the scaled first tensor and the second tensor. The third tensor is provided as input to a layer of a neural network.

### CROSS-REFERENCE TO RELATED APPLICATIONS

This application claims benefit of and priority to U.S. Provisional Patent Application Ser. No. 63/212,017, filed Jun. 17, 2021, which is herein incorporated by reference in its entirety.

### INTRODUCTION

Aspects of the present disclosure relate to machine learning techniques.

Convolution is a popular machine learning processing operation used in a wide variety of machine learning model architectures, including as part of convolutional neural network (CNN) models. For example, convolutions have been used to extract features and enable a wide variety of tasks, including signal or audio processing, computer vision, and natural language processing.

Acoustic scene classification (ASC) generally refers to the task of classifying input audio to the scene or setting (such as “airport,” “train station,” “urban park,” and the like) to which it belongs. ASC is a growing field that plays an important role in various applications, such as context-awareness and surveillance.

Processing and classifying such audio data is challenging, particularly when the audio is recorded by different devices. Frequently, different devices have their own acoustic domains, and a model trained for one set of devices often performs poorly on audio recorded by other devices.

Further, though attempts have been made to mitigate these domain imbalances, accuracy generally remains low in unseen devices, and the mitigations often cause reductions in accuracy for remaining (seen) devices. Moreover, conventional approaches to generalize the model can significantly increase model size, requiring a significant number of parameters and introducing increased computational expense.

Accordingly, techniques are needed for performing machine learning with efficient domain adaptation.

### BRIEF SUMMARY

Certain aspects provide a method, comprising: accessing a first tensor comprising a frequency dimension and a temporal dimension; generating a second tensor by applying a frequency-based instance normalization operation to the first tensor, comprising, for each respective frequency bin in the frequency dimension, computing a respective frequency-specific mean of the first tensor; generating a third tensor by: scaling the first tensor by a scale value; and aggregating the scaled first tensor and the second tensor; and providing the third tensor as input to a layer of a neural network.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow including a residual normalization operation.

FIG. 2 depicts an example workflow for processing data using a neural network with a residual normalization pre-processing operation.

FIG. 3 depicts an example workflow for processing data using a neural network with residual normalization operations between internal layers.

FIG. 4 depicts an example flow diagram illustrating a method for processing data using a residual normalization operation.

FIG. 5 depicts an example flow diagram illustrating a method for performing frequency-based instance normalization.

FIG. 6 depicts an example flow diagram illustrating a method for processing data using a neural network including one or more residual normalization operations.

FIG. 7 depicts an example flow diagram illustrating a method for processing data using a residual normalization operation for a neural network.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for residual normalization to provide efficient domain adaptation. The residual normalization techniques described herein can be applied at various stages of a neural network to suppress data differences caused by differences in the collecting devices, while maintaining or enhancing classification accuracy of the network.

The residual normalization techniques described herein can be used as efficient feature normalization operations for data processing in relation to neural networks. In one aspect, the residual normalization uses a modified instance normalization technique that is frequency-based (e.g., instance normalization within each frequency bin) to discard or suppress unnecessary device-specific information. In some aspects, the residual normalization operation further includes a shortcut path (also referred to in some aspects as a residual or residual path) to reduce or prevent loss of useful information for classification (which may be suppressed by existing normalization). In at least one aspect, the shortcut is weighted using a scale value, which may be a configurable hyperparameter or a trainable parameter of the model. Advantageously, the residual normalization techniques described herein do not increase model size (in terms of number of parameters) if the scale value is a hyperparameter. If the scale value is a trainable parameter, model sized is trivially increased (requiring one additional parameter per scale value). In either case, the residual normalization techniques can significantly improve prediction accuracy and domain adaptation.

The residual normalization operations described herein can generally be used in a variety of instances or locations in a neural network processing workflow, depending on the particular implementation. For example, the residual normalization operation may be used as a pre-processing step to prepare input data before it is provided to the neural network. In some aspects, the residual normalization operation may be performed at one or more places within the network (e.g., between layers), such as after each convolution stage.

Generally, the residual normalization techniques described herein can be applied both during training of a model, as well as during inferencing (e.g., after the model is trained). For example, during training, the training data is processed by the model to generate an output classification, which is used to compute a loss to refine the model parameters. During this forward pass, residual normalization may be used to normalize the training data (as well as intermediate data tensors internal to the model, if residual normalization is used between layers) at one or more points. Similarly, during inferencing with a trained model, newly-received input data (as well as the resulting internal data tensors, if appropriate) may be normalized using the residual normalization techniques described herein. As the residual normalization techniques described herein operate on individual instances of data (as opposed to batches of data), they are readily applicable to both training and inferencing.

In some aspects, the residual normalization techniques describe herein can be used for acoustic scene classification. In such an aspect, the input can generally correspond to recorded audio data, and the task is to identify the setting in which the audio was recorded. This can significantly improve a variety of other functions, such as improved context-awareness (allowing the system to infer the surroundings of the user) to thereby improve services. By using the disclosed residual normalization operations, neural network(s) trained using training data from a set of known (often small number of) device(s) can be readily deployed to classify data from new (unseen) devices.

Although acoustic scene classification is used in some examples discussed herein, the residual normalization techniques described herein are readily applicable to a wide variety of machine learning tasks, including other audio classification (e.g., speech recognition or classification), image analysis tasks, and the like.

Accordingly, aspects described herein overcome conventional limitations with classification and domain imbalance through efficient residual normalization that preserves or improves prediction accuracy.

### Example Workflow for Residual Normalization

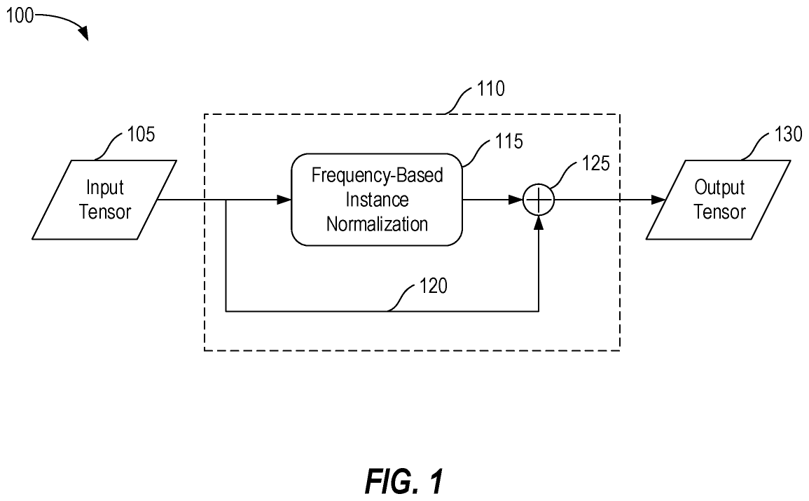

FIG. 1 depicts an example workflow 100 including a residual normalization operation 110. In the illustrated workflow 100, an input tensor 105 is processed using a residual normalization operation 110 to generate an output tensor 130.

In some examples, the input tensor 105 may be audio data (e.g., represented by a log Mel spectrogram indicating a spectrum of frequencies over time), or audio features (e.g., features generated by processing audio data). That is, the input tensor 105 may be audio input at the beginning of a network (e.g., where the residual normalization operation 110 is used as pre-processing for the network) or may be audio feature data in the middle of a network (e.g., where the residual normalization operation 110 is used between layers of the network).

In some aspects, the input tensor 105 is a multi-dimensional tensor with at least a frequency dimension and a temporal dimension. The temporal dimension may be delineated into time intervals, instances, frames, slices, windows, or steps, while the frequency dimension is delineated into bins based on frequency values or bands. The frequencies present at each time interval (e.g., the magnitude of sound at each frequency) can be reflected via the values in the tensor. In at least one aspect, the input tensor 105 can also have a channel dimension (also referred to as depth in some aspects). Additionally, in some aspects, the input tensor 105 corresponds to one sample (also referred to as an instance) in a batch of data.

Input features of input tensor 105 may be defined, for example, as x∈ [symbol] ^{N×C×F×T} where N denotes the batch size, C denotes the number of channels, F denotes the number of frequency bins, and T denotes the number of time steps. In such an aspect, a given input tensor 105 (one instance of the input) may be defined as xₙ (e.g., all elements in the n-th instance). Similarly, x_{nf} corresponds to a particular instance and frequency bin (e.g., all elements in the f-th frequency bin of the n-th instance), x_{nft} corresponds to a particular time interval for a particular frequency bin in a particular instance (e.g., all elements in the f-th frequency bin and t-th time interval of the n-th instance), while x_{ncft} corresponds to the element in the c-th channel, f-th frequency bin, and t-th time interval of the n-th instance.

In many cases, differing audio devices having differing acoustical properties can produce significantly different recordings (e.g., differing spectrograms), even when recording the same audio in the same place and at the same time. In particular, the differing devices often have different impulse response and dynamic range compression, resulting in a differing frequency response (e.g., frequency gain) at various frequencies. In the illustrated workflow, therefore, the residual normalization operation 110 uses frequency-based instance normalization 115 in order to suppress or eliminate domain differences between devices.

The frequency-based instance normalization 115 generally normalizes each instance of input data (e.g., each input tensor 105) separately (as opposed to batch normalization). Further, frequency-based instance normalization 115 may normalize each frequency bin separately, allowing frequency-related domain differences to be suppressed. That is, the frequency-based instance normalization 115 can normalize each element in a given frequency bin (e.g., x_{nf}) in view of the other elements within the same frequency bin, ignoring elements in other frequency bins.

In at least one aspect, the frequency-based instance normalization 115 may be defined using Equation 1 below, where x_{ncft} is the ncft-th element of the input tensor 105, μ_{nf} is the mean of x_{nf} (e.g., the mean of all elements in the f-th frequency band of input tensor 105), and σ_{nf} is the standard deviation of x_{nf} (e.g., the standard deviation of all elements in the f-th frequency band of input tensor 105). Additionally, σ_{nf}² corresponds to the variance of x_{nf}. One example technique for computing the mean μ_{nf} is given below in Equation 2, and one example technique for computing the variance σ_{nf}² is given below in Equation 3, where ϵ is an arbitrary (often very small) value used to prevent division by zero in the frequency-based instance normalization 115.

$$FreqIN ( {x}_{ncft} ) = \frac{{x}_{ncft} - {μ}_{nf}}{{σ}_{nf}} \qquad ( Eq . 1 )$$

$${μ}_{nf} = \frac{1}{CT} {\sum }_{c = 1}^{C} {\sum }_{t = 1}^{T} {x}_{ncft} \qquad ( Eq . 2 )$$

$${σ}_{nf}^{2} = \frac{1}{CT} {\sum }_{c = 1}^{C} {\sum }_{t = 1}^{T} {( {x}_{ncft} - {μ}_{nf} )}^{2} + ϵ \qquad ( Eq . 3 )$$

In an aspect, the frequency-based instance normalization 115 is applied to each element of the input tensor 105 to normalize the element in view of all elements within the same frequency band. That is, each element in the f-th frequency band of the input tensor 105 is normalized based on the mean and variance of all elements in the f-th frequency band.

In some aspects, though the frequency-based instance normalization 115 can efficiently suppress device differences in the input data, it may also suppress useful information that can be used to classify the input. In the illustrated example, therefore, the residual normalization operation 110 also includes a shortcut 120 (also referred to as a residual 120 in some aspects) that bypasses the frequency-based instance normalization 115. Via the shortcut 120, the original input tensor 105 and the output of the frequency-based instance normalization 115 are aggregated using the operation 125 (e.g., an element-wise summation).

In at least one aspect, the shortcut 120 is associated with a weight or scale value A which can reduce the contribution of the input tensor 105 to the output tensor 130. In one such aspect, the residual normalization operation 110 may be defined using Equation 4 below, where FreqIN(x) denotes applying frequency-based instance normalization 115 to each element of the input tensor 105 x individually (e.g., using Equations 1, 2 and 3 above).

ResNorm(x)=λ·x+FreqIN(x) (Eq. 4)

The magnitude of the scale value λ generally adjusts the contribution of the frequency-based instance normalization 115 to the output tensor 130. For example, small values for λ (e.g., near zero) cause the output tensor 130 to largely mirror the output of the frequency-based instance normalization 115, while large values cause the output tensor 130 to largely mirror the input tensor 105. In at least one aspect, the scale value λ is a real number between zero and one. In another aspect, the scale value is a real number greater than zero. In at least one aspect, rather than using the scale value to change the input tensor 105, the scale value is instead multiplied with the output of the frequency-specific (or frequency-based) instance normalization.

In some aspects, the scale value λ is a configurable hyperparameter that can be adjusted based on the particular implementation and domain. In other aspects, the scale value λ is a trainable parameter that can be learned during training of the model. Additionally, in some aspects having multiple instances of the residual normalization operation 110 (e.g., as a pre-processing step, as well as after one or more layers of the network), the scale value λ for each such residual normalization operation 110 may differ from the others, depending on the particular implementation.

The resulting output tensor 130 can be provided to further downstream processing. For example, if the residual normalization operation 110 is used as a pre-processing step, then the output tensor 130 can be provided as input to the first (input) layer of a neural network. If the residual normalization operation 110 is used within a neural network (e.g., after a convolution operation), then the output tensor 130 may be provided as input to a subsequent layer or to a pooling operation.

### Example Workflow for Residual Normalization as a Pre-Processing Operation

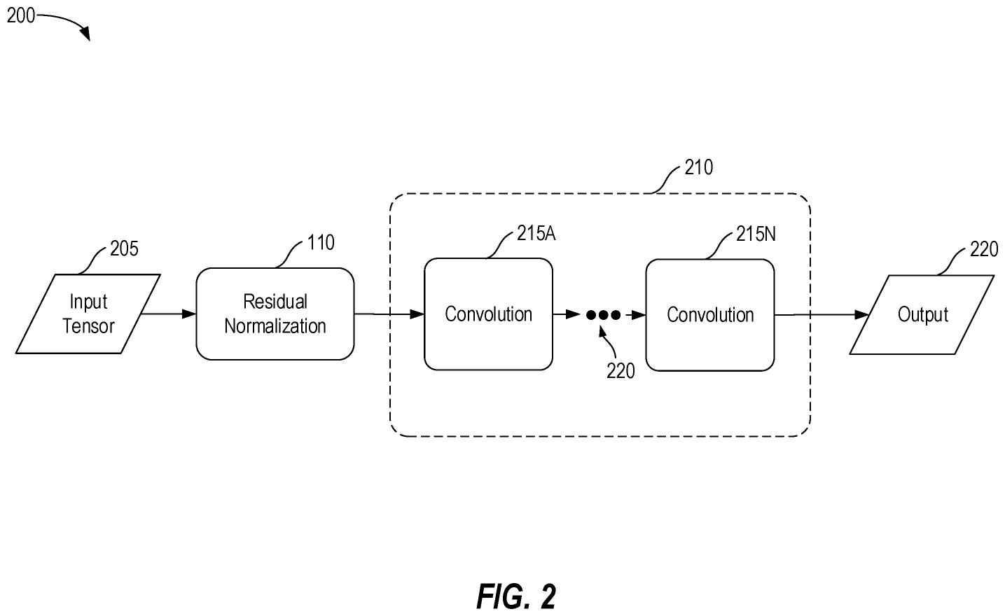

FIG. 2 depicts an example workflow 200 for processing data using a neural network 210 with a residual normalization pre-processing operation.

The neural network 210 generally includes a sequence of operations (also referred to as blocks in some aspects) applied to data tensors as they pass through the model. In the illustrated example, the neural network 210 includes one or more convolution operations 215A and 215N. Although two convolution operations 215 are depicted, in aspects, there may be any number of such convolutions (as indicated by the ellipses 220). Additionally, though not depicted in the illustrated example, in at least one aspect, the neural network 210 can also include other operations, such as pooling operations, nonlinear operations, and the like, within the network.

In the illustrated workflow 200, the residual normalization operation 110 is used as a pre-processing step. Specifically, input tensor 205 are normalized using the residual normalization operation 110, and the resulting normalized tensor is provided as input to the first (input) layer of the neural network 210. The final layer of the neural network 210 generates an output 220 (e.g., a classification of the input tensor 205). Although a single input tensor 205 is depicted for conceptual clarity, in some aspects, the workflow 200 may be used to process multiple tensors in parallel or sequence.

By using the residual normalization operation 110 as a pre-processing step, input data can be normalized without modifying the structure or architecture of the neural network 210. This can enable efficient domain adaptation.

In at least one aspect, based on a size of the network, the residual normalization operation 110 is used only for pre-processing (and not between layers of the network). In some cases, for smaller networks (e.g., with a number of parameters below a defined threshold), prediction accuracy may be greater when the residual normalization operation 110 is used for pre-processing only. In some larger models (e.g., with a number of parameters above a defined threshold), prediction accuracy may be greatest when the residual normalization operation 110 is also used within the model (e.g., between two or more layers), as discussed in more detail below. In at least one aspect, whether to use the residual normalization 110 within the neural network is decided based on weighing improved accuracy (e.g., determined by experimentation or estimated based on model size) against the additional operations required to perform the normalizations.

### Example Workflow for Residual Normalization within a Neural Network

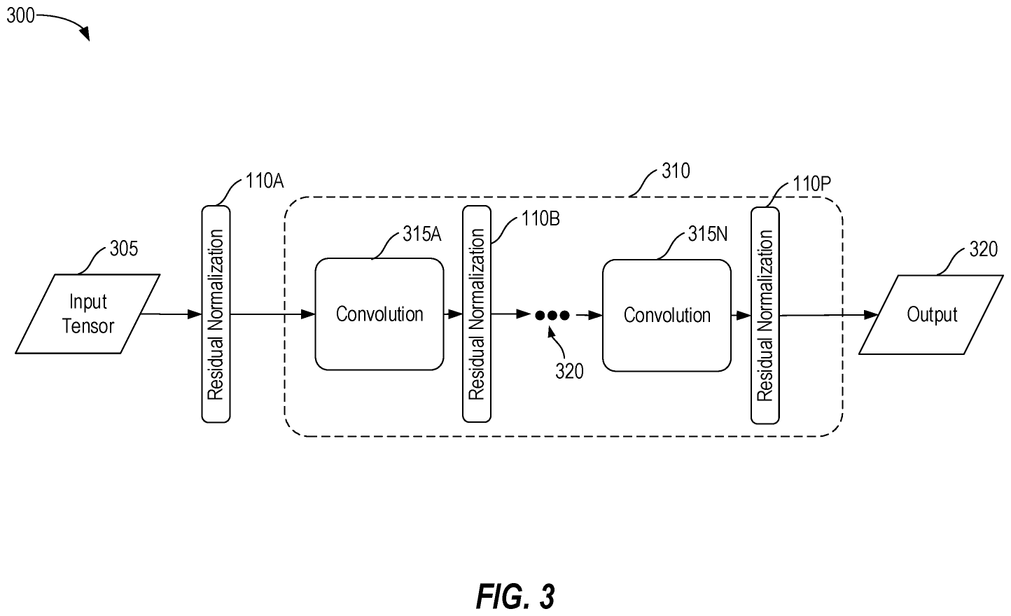

FIG. 3 depicts an example workflow 300 for processing data using a neural network 310 with residual normalization operations between internal layers.

As illustrated, the neural network 310 generally includes a sequence of operations (also referred to as blocks in some aspects) applied to data tensors as they pass through the model. Specifically, similarly to the neural network 210 depicted in FIG. 2, the neural network 310 includes one or more convolution operations 315A and 315N. Although two convolution operations 315 are depicted, in aspects, there may be any number of such convolutions (as indicated by the ellipses 320). Additionally, though not depicted in the illustrated example, in at least one aspect, the neural network 310 can also include other operations, such as pooling operations, nonlinear operations, and the like within the network.

In the illustrated workflow 300, the residual normalization operation 110A is used as a pre-processing step (in a similar manner to the workflow 200 depicted in FIG. 2). Specifically, input tensor 305 is normalized using a residual normalization operation 110A, and the resulting normalized tensor is provided as input to the first (input) layer of the neural network 310. Although a single input tensor 305 is depicted for conceptual clarity, in some aspects, the workflow 300 may be used to process multiple tensors in parallel or sequence.

Additionally, in the illustrated example, residual normalization operations are used within the neural network 310 as well. Specifically, in the illustrated neural network 310, a residual normalization operation 110B is used after the first convolution stage 315A, and a residual normalization operation 110P is used after a second convolution stage 315N. In at least one aspect, the residual normalization operations 110B and 110P are used subsequent to convolution but prior to pooling operations at each stage.

As discussed above, larger models (e.g., with a number of parameters above a defined threshold), may have improved prediction accuracy when the residual normalization operation 110 is used within the model after one or more of the internal convolutions (in addition to pre-processing). In some aspects, the residual normalization operation 110 can be used after each convolution stage. In other aspects, the residual normalization operation 110 may be selectively used after some subset of the convolutions, depending on the particular implementation. As above, the final layer of the neural network 310 generates an output 320 (e.g., a classification of the input tensor 305).

### Example Method for Processing Data Using a Residual Normalization Operation

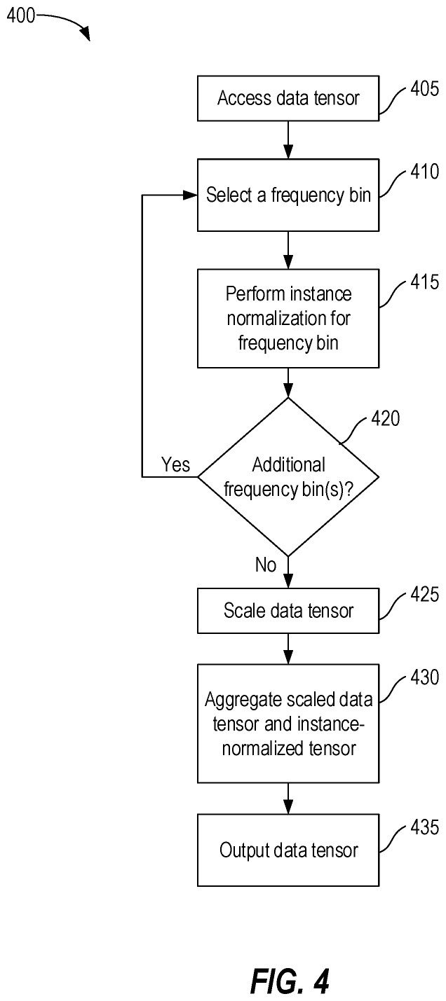

FIG. 4 depicts an example flow diagram illustrating a method 400 for processing data using a residual normalization operation. For example, the method 400 may correspond to processing data using the residual normalization operation 110 discussed above with reference to FIG. 1. As discussed above, the residual normalization operation may be performed at various stages of a neural network, including as pre-processing (before the data enters the network), as well as after one or more internal stages of the network (e.g., after a convolution step).

The method 400 begins at block 405, where a data tensor is accessed. As used herein, accessing a tensor can include a wide variety of operations and techniques to access the elements thereof. For example, the elements of a tensor may be stored (e.g., in registers, SRAM, DRAM, NVRAM, and the like) and retrieved or received from this storage. Similarly, the elements of a tensor may be pipelined and/or streamed in. As used herein, the term “accessing” (and, in some aspects, the terms “receiving” and “retrieving”) tensors or other data generally refers to a processor or other component accessing the values or elements therefrom in any suitable medium, in any suitable arrangement, and in any suitable manner.

In some aspects, this accessed data tensor includes audio data or audio feature data, as discussed above. For example, if the method 400 is used as a pre-processing step, the data tensor may include audio data (e.g., represented as a log Mel spectrogram). If the method 400 is being used internal to a network, the data tensor may correspond to an audio feature tensor. The data tensor generally includes a temporal dimension and a frequency dimension. In some aspects, the data tensor may also include a channel dimension.

As discussed above, the frequency dimension of the data tensor is generally delineated into a set of bands or sections, referred to herein as frequency bins. That is, the frequency dimension of the data tensor may be divided into F frequency bins, each corresponding to a respective set or range of specific frequencies in the data. In one example, a particular frequency bin may be defined by a highest frequency and a lowest frequency in the bin. Further, the temporal dimension of the data tensor is generally delineated into a set of steps or instances. That is, the temporal dimension of the data tensor may be divided into T time steps, each corresponding to a respective time interval in the data.

At block 410, a frequency bin, of the set of frequency bins, is selected for processing. In aspects, the frequency bin may be selected according to any criteria, as all frequency bins will be processed using the method 400. Although the illustrated example depicts sequential selection and processing of frequency bins for conceptual clarity, the system may instead process multiple frequency bins in parallel in some aspects.

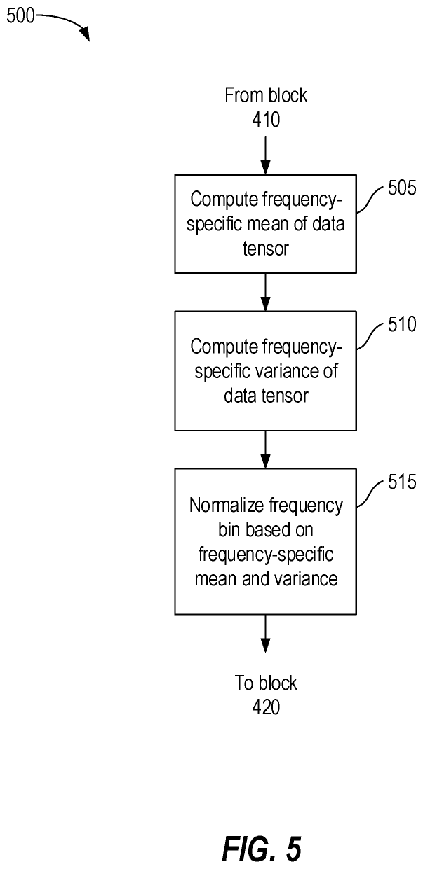

At block 415, the system performs instance normalization on the selected frequency bin. For example, the system may apply the frequency-based instance normalization 115 discussed above with reference to FIG. 1 (e.g., using Equation 1). As discussed above, this frequency-based instance normalization generally normalizes each element in the selected frequency bin (of the current instance of data reflected by the received or accessed data tensor) based on attributes of the selected frequency bin (e.g., without considering or processing elements in other frequency bins). One example of block 415 is described in more detail below, with reference to FIG. 5.

Once the selected frequency bin has been normalized, the method 400 continues to block 420, where it is determined whether at least one non-normalized frequency bin remains in the data tensor. If so, the method 400 returns to block 410. If not, the method 400 continues to block 425. In this way, the system can normalize the data tensor based on the individual frequency bins, improving domain adaptation and suppressing device differences.

At block 425, the original data tensor (accessed at block 405) is scaled based on a scale value (e.g., λ, discussed above with reference to FIG. 1 and Equation 4). As discussed above, the scale value may be a defined hyperparameter or a trainable parameter, depending on the particular implementation. In one aspect, scaling the data tensor comprises multiplying the input tensor (e.g., multiplying each individual element of the data tensor) by the scale value.

At block 430, the scaled data tensor is aggregated (e.g., via the shortcut 120 discussed with reference to FIG. 1) with the frequency-specific (also referred to as frequency-based in some aspects) instance-normalized tensor. In some aspects, this is performed using an element-wise summation. Additionally, as discussed above, in some aspects the frequency-specific instance-normalized tensor may be scaled and aggregated with the (original) data tensor.

At block 435, this aggregated data tensor is output from the residual normalization block. In aspects, the output data tensor can be used in various ways depending on the particular implementation. For example, if the method 400 is used to provide residual normalization as a pre-processing step, the data tensor can be output to the first input layer of a neural network. If the method 400 is used to provide residual normalization within the network, the output data tensor can be provided to a subsequent layer of the model (or to a pooling operation).

### Example Method for Frequency-Specific Instance Normalization

FIG. 5 depicts an example flow diagram illustrating a method 500 for performing frequency-based instance normalization. In the illustrated example, the method 500 provides additional detail for block 415 of FIG. 4.

The method 500 begins at block 505, where the system computes the frequency-specific mean (e.g., μ_{nf}) for the data tensor. That is, the system can compute the mean of the elements that are within a specific frequency bin in the input tensor. For example, Equation 2 may be used to compute this frequency-specific mean. As discussed above, the system can generally compute a separate frequency-specific mean μ_{nf} for each frequency bin x_{nf} in the data tensor xₙ.

At block 510, the system computes the frequency-specific variance (e.g., σ_{nf}²) and/or frequency-specific standard deviation (e.g., σ_{nf}) for the data tensor. That is, the system can compute the standard deviation and/or variance of the elements that are within a specific frequency bin in the input tensor. For example, Equation 3 may be used to compute this frequency-specific variance (or standard deviation, as appropriate). In a similar technique to the frequency-specific mean, the system can generally compute a separate frequency-specific variance σ_{nf}² (and/or a frequency-specific standard deviation σ_{nf}) for each frequency bin x_{nf} in the data tensor xₙ.

At block 515, the system normalizes the elements in the frequency bin based on the frequency-specific mean for the bin and the frequency-specific variance (or the frequency-specific standard deviation) for the bin. For example, in one aspect, Equation 1 may be used to normalize each element (e.g., by subtracting the frequency-specific mean μ_{nf} from the element x_{ncft}, and dividing the difference by the frequency-specific standard deviation σ_{nf}). In this way, each element in the data tensor is normalized with respect to the other elements within the same frequency bin.

Note that FIG. 5 is just one example of a method, and other methods including fewer, additional, or alternative steps are possible consistent with this disclosure.

### Example Method for Processing Data Using Residual Normalization and a Neural Network

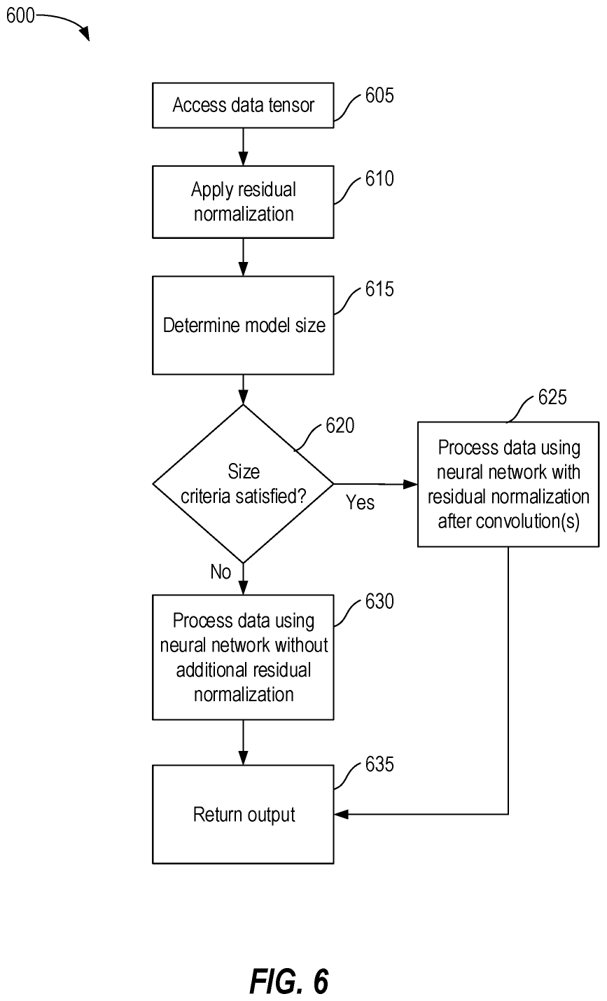

FIG. 6 depicts an example flow diagram illustrating a method 600 for processing data using a neural network including one or more residual normalization operations.

The method 600 begins at block 605, where a data tensor is accessed. In some aspects, this data tensor is audio data (e.g., a log Mel spectrogram) formatted into a tensor with temporal dimensionality and a frequency dimensionality. Generally, the temporal dimension may include a set of time instances or steps, while the frequency dimension includes a set of frequency bins or bands. In some examples, this data tensor may be provided to classify the audio into one or more appropriate categories based on the content or context of the audio (e.g., using a trained neural network). For example, for an acoustic scene classification task, the input (e.g., background or scene audio recorded in a physical location) can be analyzed to identify or infer the location (e.g., “busy street,” “train station,” “open field,” “dense forest,” and the like). The residual normalization techniques described herein can suppress device differences to enable more accurate identifications.

At block 610, the system applies a residual normalization operation (e.g., residual normalization operation 110 discussed with reference to FIG. 1) to the accessed data tensor. That is, residual normalization is used as a pre-processing step to normalize the accessed audio data before it is processed using the machine learning model.

At block 615, the system determines the size of the model. For example, if the model is a neural network, the number of parameters in the network may be determined. As discussed above, in some aspects, the residual normalization process may be used with particular efficacy for some model sizes (e.g., increasing prediction accuracy when the model is sufficiently large enough).

At block 620, the system determines whether one or more defined size criteria are satisfied. In some aspects, the size criteria includes to a defined minimum size, below which the residual normalization is used only as pre-processing. In some aspects, the size criteria includes a defined maximum size, above which the residual normalization is used after one or more convolution layers in the model. Further, in some aspects, the size criteria include a consideration for whether the increased operations of the residual normalizations are justified by the (determined or estimated) increased prediction accuracy.

In some aspects, the residual normalization techniques may be selectively applied with differing scale values based on the size of the model. For example, residual normalization may be used within the model with a scale value relatively closer to one (reducing the impact of the frequency-specific normalization) when the model is small, while a smaller scale value (relatively closer to zero) may be used to increase the impact of the frequency-specific normalization in larger models. Additionally, in various aspects, residual normalization techniques may be applied with differing scale values at different points in the model, depending on the particular implementation.

If, at block 620, the system determines that the size criteria are not satisfied, the method 600 continues to block 630, where the (normalized) data tensor is processed using the neural network without further residual normalization. For example, the workflow 200 of FIG. 2 may be used. The method 600 then continues to block 635 to return the output of the model (e.g., a classification of the input data tensor).

Returning to block 620, if the system determines that the size criteria are satisfied, the method 600 continues to block 625. At block 625, the (normalized) data tensor is processed using a neural network with one or more residual normalization steps after one or more internal convolutions. In one aspect, the system can apply residual normalization after each convolution. In another aspect, the system may apply the residual normalization after a subset of the convolutions, depending on the particular implementation (and, in some instances, depending on the size of the model). The method 600 then continues to block 635 to return the model output.

Note that FIG. 6 is just one example of a method, and other methods including fewer, additional, or alternative steps are possible consistent with this disclosure.

### Example Method for Residual Normalization

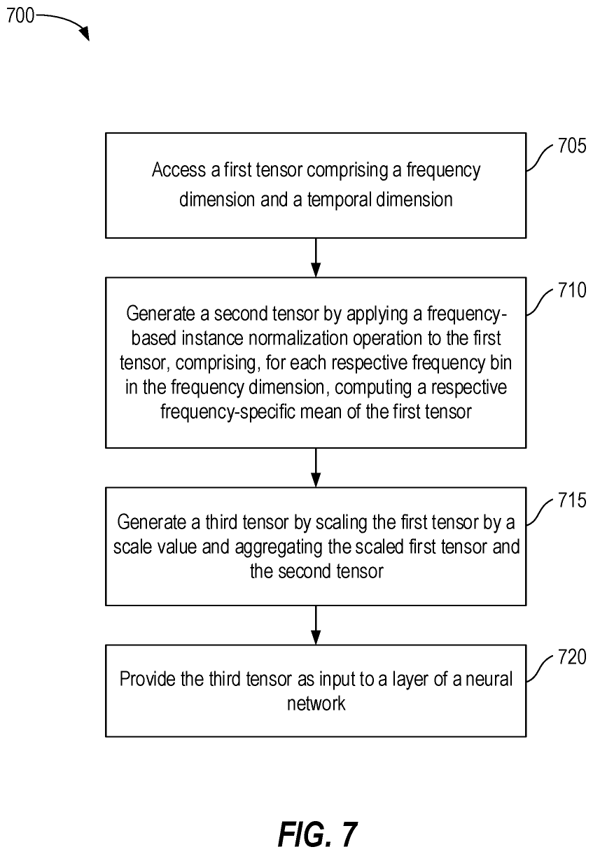

FIG. 7 depicts an example flow diagram illustrating a method 700 for processing data using a residual normalization operation for a neural network.

At block 705, a first tensor comprising a frequency dimension and a temporal dimension is accessed.

At block 710, a second tensor is generated by applying a frequency-based instance normalization operation to the first tensor, comprising, for each respective frequency bin in the frequency dimension, computing a respective frequency-specific mean of the first tensor.

In some aspects, applying the frequency-based instance normalization operation further comprises, for each respective frequency bin in the frequency dimension: computing a respective frequency-specific variance of the first tensor.

In some aspects, applying the frequency-based instance normalization operation further comprises, for each respective frequency bin in the frequency dimension, computing a respective frequency-specific difference between the first tensor and the respective frequency-specific mean of the first tensor and dividing the respective frequency-specific difference by the respective frequency-specific variance of the first tensor.

At block 715, a third tensor is generated by scaling the first tensor by a scale value and aggregating the scaled first tensor and the second tensor.

In some aspects, the scale value is a configurable hyperparameter of the neural network.

In some aspects, the scale value is a trainable parameter of the neural network.

At block 720, the third tensor is provided as input to a layer of a neural network.

In some aspects, the layer of the neural network is an input layer at a start of the neural network.

In some aspects, the layer of the neural network is an intermediate layer within the neural network.

In some aspects, the method 700 further comprises applying the frequency-based instance normalization operation as a pre-processing operation prior to processing an input layer of the neural network, wherein the third tensor is provided as input to the input layer of the neural network.

In some aspects, the method 700 further comprises determining a size of the neural network, and refraining from applying the frequency-based instance normalization operation between layers of the neural network, based on determining that the size is below a defined threshold.

In some aspects, the method 700 further comprises applying the frequency-based instance normalization operation after each convolution stage, of a plurality of convolution stages, in the neural network.

In some aspects, the method 700 further comprises determining a size of the neural network, wherein the frequency-based instance normalization operation after each convolution stage based on determining that the size is above a defined threshold.

Note that FIG. 7 is just one example of a method, and other methods including fewer, additional, or alternative steps are possible consistent with this disclosure.

### Example Processing System for Residual Normalization

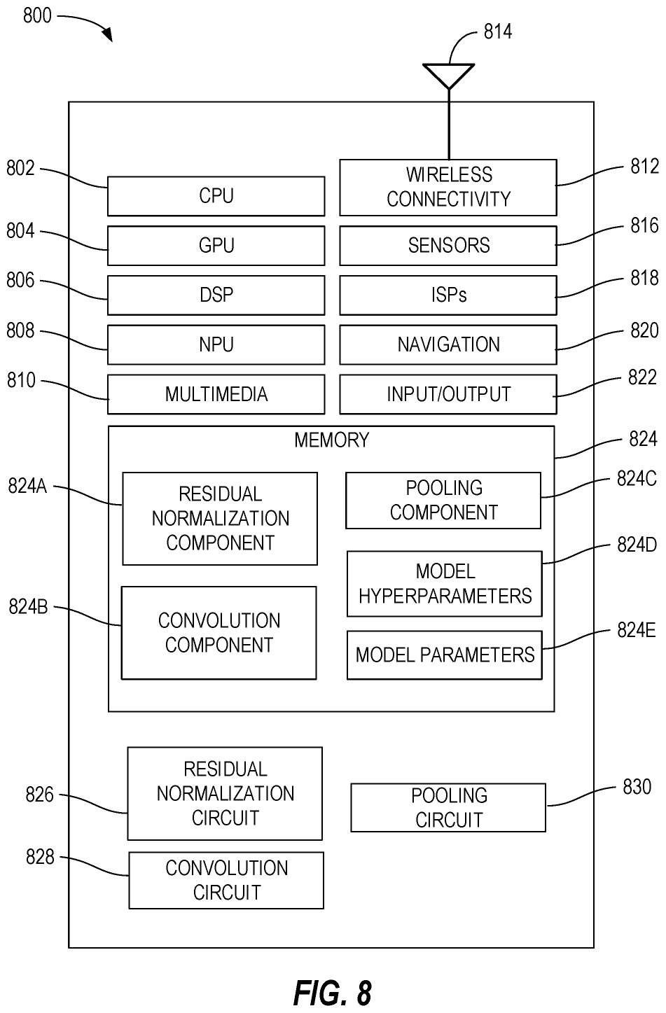

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7.

Processing system 800 includes a central processing unit (CPU) 802, which in some examples may be a multi-core CPU. Instructions executed at the CPU 802 may be loaded, for example, from a program memory associated with the CPU 802 or may be loaded from a memory partition 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a residual normalization component 824A, a convolution component 824B, and a pooling component 824C. The memory 824 also includes model hyperparameters 824D and model parameters 824E. The depicted components, and others not depicted, may be configured to perform various aspects of the techniques described herein. Though depicted as discrete components for conceptual clarity in FIG. 8, residual normalization component 824A, convolution component 824B, and pooling component 824C may be collectively or individually implemented in various aspects.

Processing system 800 further comprises residual normalization circuit 826, convolution circuit 828, and pooling circuit 830. The depicted circuits, and others not depicted, may be configured to perform various aspects of the techniques described herein.

For example, residual normalization component 824A and residual normalization circuit 826 may be used to perform the residual normalization techniques discussed above. Convolution component 824B and convolution circuit 828 may be used to convolve the data tensors within a neural network, and pooling component 824C and pooling circuit 830 may be used to perform data pooling within a neural network. Model hyperparameters 824D can generally include hyperparameters for the model (such as, in some aspects, the scale value for one or more residual normalizations), while the model parameters 824E can include trainable parameters (such as weights and, in some aspects, the scale value for one or more residual normalizations).

Though depicted as separate components and circuits for clarity in FIG. 8, residual normalization circuit 826, convolution circuit 828, and pooling circuit 830 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia component 810, wireless connectivity 812, sensors 816, ISPs 818, and/or navigation component 820 may be omitted in other aspects. Further, aspects of processing system 800 maybe distributed between multiple devices.

### Example Clauses

Clause 1: A method, comprising: accessing a first tensor comprising a frequency dimension and a temporal dimension; generating a second tensor by applying a frequency-based instance normalization operation to the first tensor, comprising, for each respective frequency bin in the frequency dimension, computing a respective frequency-specific mean of the first tensor; generating a third tensor by: scaling the first tensor by a scale value; and aggregating the scaled first tensor and the second tensor; and providing the third tensor as input to a layer of a neural network.

Clause 2: The method according to Clause 1, wherein applying the frequency-based instance normalization operation further comprises, for each respective frequency bin in the frequency dimension: computing a respective frequency-specific variance of the first tensor.

Clause 3: The method according to any one of Clauses 1-2, wherein applying the frequency-based instance normalization operation further comprises, for each respective frequency bin in the frequency dimension: computing a respective frequency-specific difference between the first tensor and the respective frequency-specific mean of the first tensor; and dividing the respective frequency-specific difference by the respective frequency-specific variance of the first tensor.

Clause 4: The method according to any one of Clauses 1-3, wherein the layer of the neural network is an input layer at a start of the neural network.

Clause 5: The method according to any one of Clauses 1-4, wherein the layer of the neural network is an input layer at a start of the neural network.

Clause 6: The method according to any one of Clauses 1-5, wherein the scale value is a configurable hyperparameter of the neural network.

Clause 7: The method according to any one of Clauses 1-6, wherein the scale value is a trainable parameter of the neural network.

Clause 8: The method according to any one of Clauses 1-7, further comprising applying the frequency-based instance normalization operation as a pre-processing operation prior to processing an input layer of the neural network, wherein the third tensor is provided as input to the input layer of the neural network.

Clause 9: The method according to any one of Clauses 1-8, further comprising: determining a size of the neural network; and refraining from applying the frequency-based instance normalization operation between layers of the neural network, based on determining that the size is below a defined threshold.

Clause 10: The method according to any one of Clauses 1-9, further comprising: applying the frequency-based instance normalization operation after each convolution stage, of a plurality of convolution stages, in the neural network.

Clause 11: The method according to any one of Clauses 1-10, further comprising: determining a size of the neural network, wherein the frequency-based instance normalization operation after each convolution stage based on determining that the size is above a defined threshold.

Clause 12: A system, comprising: a memory comprising computer-executable instructions; and one or more processors configured to execute the computer-executable instructions and cause the processing system to perform a method in accordance with any one of Clauses 1-11.

Clause 13: A system, comprising means for performing a method in accordance with any one of Clauses 1-11.

Clause 14: A non-transitory computer-readable medium comprising computer-executable instructions that, when executed by one or more processors of a processing system, cause the processing system to perform a method in accordance with any one of Clauses 1-11.

Clause 15: A computer program product embodied on a computer-readable storage medium comprising code for performing a method in accordance with any one of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
accessing a first tensor comprising a frequency dimension and a temporal dimension;
generating a second tensor by applying a frequency-based instance normalization operation to the first tensor, comprising, for each respective frequency bin in the frequency dimension, computing a respective frequency-specific mean of the first tensor;
generating a third tensor by:
scaling the first tensor by a scale value; and
aggregating the scaled first tensor and the second tensor; and
providing the third tensor as input to a layer of a neural network.

2. The processor-implemented method of claim 1, wherein applying the frequency-based instance normalization operation further comprises, for each respective frequency bin in the frequency dimension: computing a respective frequency-specific variance of the first tensor.

3. The processor-implemented method of claim 2, wherein applying the frequency-based instance normalization operation further comprises, for each respective frequency bin in the frequency dimension:
computing a respective frequency-specific difference between the first tensor and the respective frequency-specific mean of the first tensor; and
dividing the respective frequency-specific difference by the respective frequency-specific variance of the first tensor.

4. The processor-implemented method of claim 1, wherein the layer of the neural network is an input layer at a start of the neural network.

5. The processor-implemented method of claim 1, wherein the layer of the neural network is an intermediate layer within the neural network.

6. The processor-implemented method of claim 1, wherein the scale value is a configurable hyperparameter of the neural network.

7. The processor-implemented method of claim 1, wherein the scale value is a trainable parameter of the neural network.

8. The processor-implemented method of claim 1, further comprising applying the frequency-based instance normalization operation as a pre-processing operation prior to processing an input layer of the neural network, wherein the third tensor is provided as input to the input layer of the neural network.

9. The processor-implemented method of claim 8, further comprising:
determining a size of the neural network; and
refraining from applying the frequency-based instance normalization operation between layers of the neural network, based on determining that the size is below a defined threshold.

10. The processor-implemented method of claim 8, further comprising:
applying the frequency-based instance normalization operation after each convolution stage, of a plurality of convolution stages, in the neural network.

11. The processor-implemented method of claim 10, further comprising:
determining a size of the neural network, wherein the frequency-based instance normalization operation after each convolution stage based on determining that the size is above a defined threshold.

12. A processing system, comprising:
a memory comprising computer-executable instructions; and
one or more processors configured to execute the computer-executable instructions and cause the processing system to perform an operation comprising:
accessing a first tensor comprising a frequency dimension and a temporal dimension;
generating a second tensor by applying a frequency-based instance normalization operation to the first tensor, comprising, for each respective frequency bin in the frequency dimension, computing a respective frequency-specific mean of the first tensor;
generating a third tensor by:
scaling the first tensor by a scale value; and
aggregating the scaled first tensor and the second tensor; and
providing the third tensor as input to a layer of a neural network.

13. The processing system of claim 12, wherein applying the frequency-based instance normalization operation further comprises, for each respective frequency bin in the frequency dimension: computing a respective frequency-specific variance of the first tensor.

14. The processing system of claim 13, wherein applying the frequency-based instance normalization operation further comprises, for each respective frequency bin in the frequency dimension:
computing a respective frequency-specific difference between the first tensor and the respective frequency-specific mean of the first tensor; and
dividing the respective frequency-specific difference by the respective frequency-specific variance of the first tensor.

15. The processing system of claim 12, wherein the layer of the neural network is an input layer at a start of the neural network.

16. The processing system of claim 12, wherein the layer of the neural network is an intermediate layer within the neural network.

17. The processing system of claim 12, the operation further comprising applying the frequency-based instance normalization operation as a pre-processing operation prior to processing an input layer of the neural network, wherein the third tensor is provided as input to the input layer of the neural network.

18. The processing system of claim 17, the operation further comprising:
determining a size of the neural network; and
refraining from applying the frequency-based instance normalization operation between layers of the neural network, based on determining that the size is below a defined threshold.

19. The processing system of claim 17, the operation further comprising:
applying the frequency-based instance normalization operation after each convolution stage, of a plurality of convolution stages, in the neural network.

20. The processing system of claim 19, the operation further comprising:
determining a size of the neural network, wherein the frequency-based instance normalization operation after each convolution stage based on determining that the size is above a defined threshold.

21. A non-transitory computer-readable medium comprising computer-executable instructions that, when executed by one or more processors of a processing system, cause the processing system to perform an operation comprising:
accessing a first tensor comprising a frequency dimension and a temporal dimension;
generating a second tensor by applying a frequency-based instance normalization operation to the first tensor, comprising, for each respective frequency bin in the frequency dimension, computing a respective frequency-specific mean of the first tensor;
generating a third tensor by:
scaling the first tensor by a scale value; and
aggregating the scaled first tensor and the second tensor; and
providing the third tensor as input to a layer of a neural network.

22. The non-transitory computer-readable medium of claim 21, wherein applying the frequency-based instance normalization operation further comprises, for each respective frequency bin in the frequency dimension: computing a respective frequency-specific variance of the first tensor.

23. The non-transitory computer-readable medium of claim 22, wherein applying the frequency-based instance normalization operation further comprises, for each respective frequency bin in the frequency dimension:
computing a respective frequency-specific difference between the first tensor and the respective frequency-specific mean of the first tensor; and
dividing the respective frequency-specific difference by the respective frequency-specific variance of the first tensor.

24. The non-transitory computer-readable medium of claim 21, wherein the layer of the neural network is an input layer at a start of the neural network.

25. The non-transitory computer-readable medium of claim 21, wherein the layer of the neural network is an intermediate layer within the neural network.

26. The non-transitory computer-readable medium of claim 21, the operation further comprising applying the frequency-based instance normalization operation as a pre-processing operation prior to processing an input layer of the neural network, wherein the third tensor is provided as input to the input layer of the neural network.

27. The non-transitory computer-readable medium of claim 26, the operation further comprising:
determining a size of the neural network; and
refraining from applying the frequency-based instance normalization operation between layers of the neural network, based on determining that the size is below a defined threshold.

28. The non-transitory computer-readable medium of claim 26, the operation further comprising:
applying the frequency-based instance normalization operation after each convolution stage, of a plurality of convolution stages, in the neural network.

29. The non-transitory computer-readable medium of claim 28, the operation further comprising:
determining a size of the neural network, wherein the frequency-based instance normalization operation after each convolution stage based on determining that the size is above a defined threshold.

30. A processing system, comprising:
means for receiving a first tensor comprising a frequency dimension and a temporal dimension;
means for generating a second tensor by applying a frequency-based instance normalization operation to the first tensor, comprising, for each respective frequency bin in the frequency dimension, computing a respective frequency-specific mean of the first tensor;
means for generating a third tensor by:
scaling the first tensor by a scale value; and
aggregating the scaled first tensor and the second tensor; and
means for providing the third tensor as input to a layer of a neural network.
